(19) United States
(12) Patent Application Publication
(10) Pub. No.: US 2023/0212989 A1
(43) Pub. Date: Jul. 6, 2023

(54) BLEED VALVE ASSEMBLIES

(71) Applicant: General Electric Company, Schenectady, NY (US)

(72) Inventors: Thomas Malkus, Albany, NY (US); Jeffrey D. Carnes, Framingham, MA (US); Giridhar Jothiprasad, Clifton Park, NY (US); Christopher E. LaMaster, Franklin, OH (US); Michael Macrorie, Winchester, MA (US); Trevor H. Wood, Clifton Park, NY (US); Steven M. Taylor, Evendale, OH (US); Mitchell J. Headley, West Chester, OH (US); Paul J. Trimby, Essex, MA (US)

(21) Appl. No.: 17/569,293

(22) Filed: Jan. 5, 2022

(51) Int. Cl. F02C 9/18; F02C 6/08

(52) U.S. Cl. CPC F02C 9/18; F02C 6/08

(57) ABSTRACT

Methods, apparatus, systems, and articles of manufacture are disclosed for a variable bleed valve assembly. An example variable bleed valve assembly includes a variable bleed valve (VBV) door corresponding to a bleed port, an intermediary device operatively coupled to the VBV door, and a first actuator operatively coupled to the intermediary device, the first actuator to move between a first position and a second position, the first actuator to cause the intermediary device to move between the first position and the second position to cause the VBV door to move between the first position and the second position.

### FIELD OF THE DISCLOSURE

This disclosure relates generally to turbine engines and, more particularly, to various bleed valve assemblies.

### BACKGROUND

Turbine engines are some of the most widely-used power generating technologies, often being utilized in aircraft and power-generation applications. A turbine engine generally includes a fan and a core arranged in flow communication with one another. The core of the turbine engine generally includes, in serial flow order, a compressor section, a combustion section, a turbine section on the same shaft as the compressor section, and an exhaust section. Typically, a casing or housing surrounds the core of the turbine engine.

### BRIEF DESCRIPTION OF THE DRAWINGS

FIG. 1 is a cross-sectional view of an example gas turbine engine in which examples disclosed herein may be implemented.

FIG. 2 is an illustration of an example variable bleed valve port for which examples disclosed herein may be implemented.

FIGS. 3A and 3B illustrate an example casing for a compressor, including example variable bleed valve ports for which examples disclosed herein may be implemented.

FIGS. 4A and 4B illustrate the example casing of FIGS. 3A and 3B including an example variable bleed valve assembly structured in accordance with the teachings of this disclosure.

FIGS. 5A-5B illustrate another example variable bleed valve assembly structured in accordance with the teachings of this disclosure.

FIGS. 6A-6B illustrate another example variable bleed valve assembly structured in accordance with the teachings of this disclosure.

FIGS. 7A-7B illustrate the example variable bleed valve assembly of FIGS. 6A and 6B including an example unison ring structured in accordance with the teachings of this disclosure.

FIGS. 8A-8B illustrate another example variable bleed valve assembly structured in accordance with the teachings of this disclosure.

FIGS. 9A-9D illustrate the example variable bleed assembly of FIGS. 8A-8B and/or 10A-10B in accordance with the teachings of this disclosure.

FIGS. 10A-10B illustrate another example variable bleed valve assembly structured in accordance with the teachings of this disclosure.

FIGS. 11A-11B illustrate another example variable bleed valve assembly structured in accordance with the teachings of this disclosure.

FIG. 12 illustrates the example variable bleed valve assembly of FIGS. 11A-11B structured in accordance with the teachings of this disclosure.

FIGS. 13A-13B illustrate another example variable bleed valve assembly structured in accordance with the teachings of this disclosure.

FIG. 14 illustrates the example variable bleed valve assembly of FIGS. 13A-13B structured in accordance with the teachings of this disclosure.

FIGS. 15A-15B illustrate another example variable bleed valve assembly structured in accordance with the teachings of this disclosure.

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In some examples used herein, the term “substantially” is used to describe a relationship between two parts that is within three degrees of the stated relationship (e.g., a substantially colinear relationship is within three degrees of being linear, a substantially perpendicular relationship is within three degrees of being perpendicular, a substantially parallel relationship is within three degrees of being parallel, a substantially flush relationship is within three degrees of being flush, etc.).

The terms “upstream” and “downstream” refer to the relative direction with respect to fluid flow in a fluid pathway. For example, “upstream” refers to the direction from which the fluid flows, and “downstream” refers to the direction to which the fluid flows. Various terms are used herein to describe the orientation of features. In general, the attached figures are annotated with reference to the axial direction, radial direction, and circumferential direction of the vehicle associated with the features, forces and moments. In general, the attached figures are annotated with a set of axes including the axial axis A, the radial axis R, and the circumferential axis C.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore, provided to describe an exemplary implementation and not to be taken limiting on the scope of the subject matter described in this disclosure. Certain features from different aspects of the following description may be combined to form yet new aspects of the subject matter discussed below.

### DETAILED DESCRIPTION

A turbine engine, also referred to herein as a gas turbine engine, is a type of internal combustion engine that uses atmospheric air as a moving fluid. In operation, atmospheric air enters the turbine engine via a fan and flows through a compressor section where one or more compressors progressively compresses (e.g., pressurizes) the air until it reaches the combustion section. The pressurized air is combined with fuel in the combustion section and ignited to produce a high-temperature, high-pressure gas stream (e.g., hot combustion gas). The hot combustion gases expand as they flow a through a turbine section, causing rotating blades of one or more turbines to spin. The rotating blades of the turbine produce a spool work output that powers a corresponding compressor. The spool is a combination of the compressor, a shaft, and the turbine. Many turbine engines include multiple spools, such as a high pressure spool (e.g., HP compressor, shaft, and turbine) and a low pressure spool (e.g., LP compressor, shaft, and turbine). However, a turbine engine can include one spool or more than two spools in additional or alternative examples.

During low speed operation of the turbine engine (e.g., during start-up and/or stopping), equilibrium of the engine is adjusted. In many scenarios, a delay is needed for the spool(s) to adapt (e.g., a time for a rotational speed to adjust for a new equilibrium). However, the compressor cannot stop producing pressurized air for the fuel combustion during operation. Such a result may cause the turbine to stop producing the power to turn the compressor, causing the compressor itself to stop compressing air. Accordingly, throttling changes may lead to compressor instabilities, such as compressor stall and/or compressor surge. Compressor stall is a circumstance of abnormal airflow resulting from the aerodynamic stall of rotor blades within the compressor. Compressor stall causes the air flowing through the compressor to slow down or stagnate. $In some cases, the disruption of air flow as the air passes through various stages of the compressor can lead to compressor surge. Compressor surge refers to a stall that results in disruption (e.g., complete disruption, majority disruption, other partial disruption, etc.) of the airflow through the compressor.

A variable bleed valve (VBV) is often integrated into a compressor to increase efficiency and limit possible stalls. The VBV enables the turbine engine to bleed air from a compressor section of the turbine engine during operation. An example VBV assembly includes a VBV port (e.g., opening, air bleed slot, etc.) in a compressor casing that opens via actuation of a VBV door. In other words, the VBV is configured as a door that opens to provide a bleed flowpath to bleed off compressed air between a booster (e.g., a low pressure compressor) and a core engine compressor of a gas turbine. For example, the VBV door may be actuated during a speed-speed mismatch between the LP spool and the HP spool. During start-up or stopping, the HP spool may spin at a lower speed than the LP spool. Opening the VBV port allows the LP spool to maintain its speed while reducing the amount of air that is flowing through the axial compressor by directing some of the air flow to the turbine exhaust area. Thus, the VBV door enables the LP spool (e.g., booster) to operate on a lower operating line and further away from a potential instability or stall condition.

When a VBV is in a closed position, the VBV door may not be flush with the compressor casing, resulting in a bleed cavity that is open to a main flow path within the compressor. This results in aerodynamic performance losses in the main flow path and/or flow induced cavity oscillations. Accordingly, a new VBV assembly is needed that addresses the issues described above.

Examples disclosed herein enable manufacture of a VBV assembly that improves aerodynamic performance and/or efficiency of a turbine engine. Certain examples enable a VBV assembly in which a surface of a VBV door is flush with a casing wall when the VBV door is in a closed position. Accordingly, certain examples reduce and/or minimize a volume of the bleed cavity. Certain examples disclosed herein may eliminate the bleed cavity. Certain example VBV assemblies may be heavier than current VBV doors. Certain examples thus improve aerodynamic efficiency and minimize or otherwise reduce aero-acoustic excitations in the bleed cavity.

Examples disclosed herein enable manufacture of a variety of VBV assemblies. In some examples, a sliding door is used to move a VBV between a closed and open position. In some examples, the VBV doors are actuated individually. In some examples, a unison ring is utilized to actuate a plurality of VBV doors concurrently. In some examples, a plurality of unison rings are utilized, enabling a sub-set of VBV doors to actuate concurrently. Certain examples enable partial actuation of a VBV door (e.g., the VBV door opens and/or closes partially). In some examples, a hinged VBV door is used to move a VBV between the closed and opened positions.

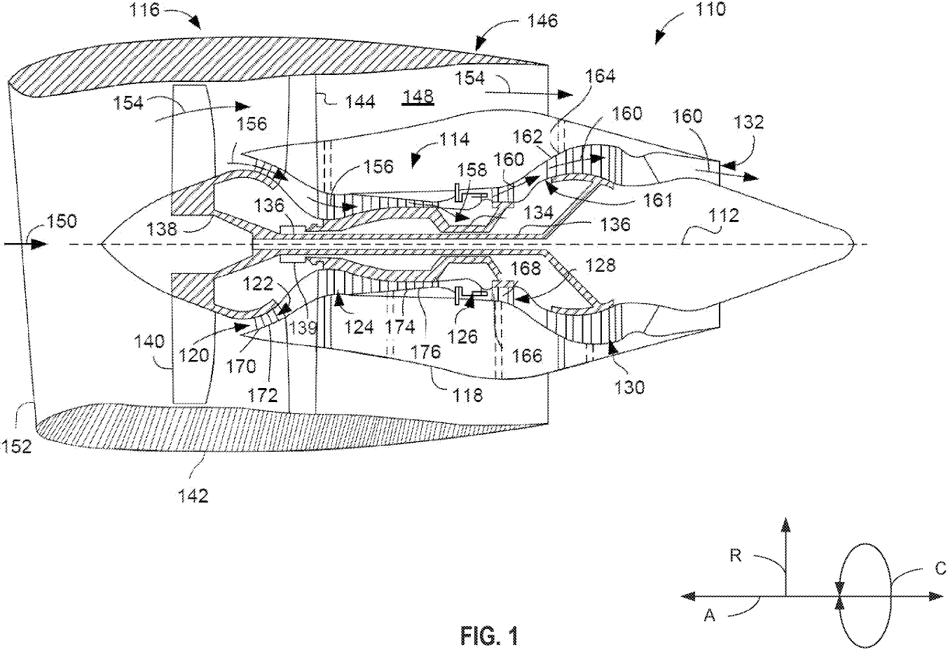

Referring now to the drawings, wherein identical numerals indicate the same elements throughout the figures, FIG. 1 is a schematic cross-sectional view of an example high-bypass turbofan-type gas turbine engine 110 (“turbofan engine 110”). While the illustrated example is a high-bypass turbofan engine, the principles of the present disclosure are also applicable to other types of engines, such as low-bypass turbofans, turbojets, turboprops, etc. As shown in FIG. 1, the turbofan engine 110 defines a longitudinal or axial centerline axis 112 extending therethrough for reference. FIG. 1 also includes an annotated directional diagram with reference to an axial direction A, a radial direction R, and a circumferential direction C. In general, as used herein, the axial direction A is a direction that extends generally parallel to the centerline axis 112, the radial direction R is a direction that extends orthogonally outwardly from the centerline axis 112, and the circumferential direction C is a direction that extends concentrically around the centerline axis 112.

In general, the turbofan engine 110 includes a core turbine or gas turbine engine 114 disposed downstream from a fan section 116. The core turbine 114 includes a substantially tubular outer casing 118 that defines an annular inlet 120. The outer casing 118 can be formed from a single casing or multiple casings. The outer casing 118 encloses, in serial flow relationship, a compressor section having a booster or low pressure compressor 122 (“LP compressor 122”) and a high pressure compressor 124 (“HP compressor 124”), a combustion section 126, a turbine section having a high pressure turbine 128 (“HP turbine 128”) and a low pressure turbine 130 (“LP turbine 130”), and an exhaust section 132. A high pressure shaft or spool 134 (“HP shaft 134”) drivingly couples the HP turbine 128 and the HP compressor 124. A low pressure shaft or spool 136 (“LP shaft 136”) drivingly couples the LP turbine 130 and the LP compressor 122. The LP shaft 136 can also couple to a fan spool or shaft 138 of the fan section 116. In some examples, the LP shaft 136 is coupled directly to the fan shaft 138 (e.g., a direct-drive configuration). In alternative configurations, the LP shaft 136 can couple to the fan shaft 138 via a reduction gear 139 (e.g., an indirect-drive or geared-drive configuration).

As shown in FIG. 1, the fan section 116 includes a plurality of fan blades 140 coupled to and extending radially outwardly from the fan shaft 138. An annular fan casing or nacelle 142 circumferentially encloses the fan section 116 and/or at least a portion of the core turbine 114. The nacelle 142 can be supported relative to the core turbine 114 by a plurality of circumferentially-spaced apart outlet guide vanes 144. Furthermore, a downstream section 146 of the nacelle 142 can enclose an outer portion of the core turbine 114 to define a bypass airflow passage 148 therebetween.

As illustrated in FIG. 1, air 150 enters an inlet portion 152 of the turbofan engine 110 during operation thereof. A first portion 154 of the air 150 flows into the bypass airflow passage 148, while a second portion 156 of the air 150 flows into the inlet 120 of the LP compressor 122. One or more sequential stages of LP compressor stator vanes 170 and LP compressor rotor blades 172 coupled to the LP shaft 136 progressively compress the second portion 156 of the air 150 flowing through the LP compressor 122 en route to the HP compressor 124. Next, one or more sequential stages of HP compressor stator vanes 174 and HP compressor rotor blades 176 coupled to the HP shaft 134 further compress the second portion 156 of the air 150 flowing through the HP compressor 124. This provides compressed air 158 to the combustion section 126 where it mixes with fuel and burns to provide combustion gases 160.

The combustion gases 160 flow through the HP turbine 128 where one or more sequential stages of HP turbine stator vanes 166 and HP turbine rotor blades 168 coupled to the HP shaft 134 extract a first portion of kinetic and/or thermal energy therefrom. This energy extraction supports operation of the HP compressor 124. The combustion gases 160 then flow through the LP turbine 130 where one or more sequential stages of LP turbine stator vanes 162 and LP turbine rotor blades 164 coupled to the LP shaft 136 extract a second portion of thermal and/or kinetic energy therefrom. This energy extraction causes the LP shaft 136 to rotate, thereby supporting operation of the LP compressor 122 and/or rotation of the fan shaft 138. The combustion gases 160 then exit the core turbine 114 through the exhaust section 132 thereof. A turbine frame 161 with a fairing assembly is located between the HP turbine 128 and the LP turbine 130. The turbine frame 161 acts as a supporting structure, connecting a high-pressure shaft’s rear bearing with the turbine housing and forming an aerodynamic transition duct between the HP turbine 128 and the LP turbine 130. Fairings form a flow path between the high-pressure and low-pressure turbines and can be formed using metallic castings (e.g., nickel-based cast metallic alloys, etc.).

Along with the turbofan engine 110, the core turbine 114 serves a similar purpose and is exposed to a similar environment in land-based gas turbines, turbojet engines in which the ratio of the first portion 154 of the air 150 to the second portion 156 of the air 150 is less than that of a turbofan, and unducted fan engines in which the fan section 116 is devoid of the nacelle 142. In each of the turbofan, turbojet, and unducted engines, a speed reduction device (e.g., the reduction gear 139) can be included between any shafts and spools. For example, the reduction gear 139 is disposed between the LP shaft 136 and the fan shaft 138 of the fan section 116.

As described above with respect to FIG. 1, the turbine frame 161 is located between the HP turbine 128 and the LP turbine 130 to connect the high-pressure shaft’s rear bearing with the turbine housing and form an aerodynamic transition duct between the HP turbine 128 and the LP turbine 130. As such, air flows through the turbine frame 161 between the HP turbine 128 and the LP turbine 130.

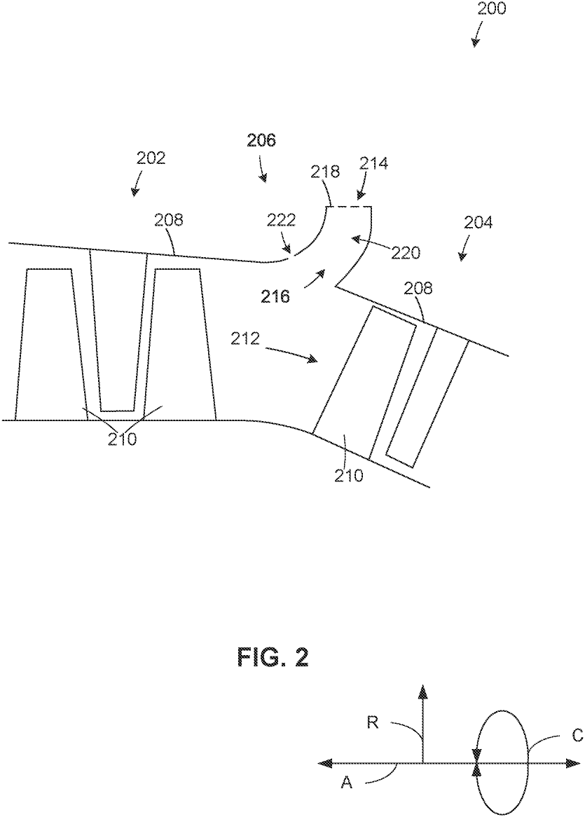

FIG. 2 is an illustration of a partial cross-sectional view of an example compressor 200 of a turbine engine (e.g., turbofan engine 110 of FIG. 1), including an example LP compressor (e.g., booster) stage 202 and an example HP compressor stage 204. FIG. 2 illustrates the example compressor 200 at a transition point 206 between the booster stage 202 and the HP compressor stage 204. The compressor 200 includes an example casing 208. In the illustrated example of FIG. 2, the casing 208 surrounds the booster stage 202 and the HP compressor stage 204. In additional or alternative examples, the booster stage 202 and the HP compressor stage 204 have distinct casings 208 connected via a linkage mechanism. The casing 208 surrounds rotor blades 210 of the compressor 200. In operation, the rotor blades 210 spin, impelling air downstream. The casing 208 defines an example mainstream flowpath 212 (e.g., a first flowpath) for airflow through compressor 200 (e.g., and the turbofan engine 110).

FIG. 2 illustrates an example VBV port (e.g., opening, duct, etc.) 214 that defines an example bleed flowpath (e.g., secondary flowpath) 216. In many VBV assemblies, a VBV door (omitted in FIG. 2) is located at the VBV port’s exit 218. Such an assembly may result in an example bleed cavity 220, which may disrupt airflow as the air flows through the mainstream flowpath 212. For example, the bleed cavity 220 may cause acoustic resonance, which can lead to compressor instabilities. Advantageously, certain examples disclosed herein include an example VBV door gap 222 that allows a VBV door to slide in and out between an open position and a closed position. The VBV door gap 222 allows the VBV door to remain flush with the casing 208 in a closed position, thus eliminating and/or limiting the bleed cavity 220 and impacts of the bleed cavity 220 on the mainstream flowpath 212.

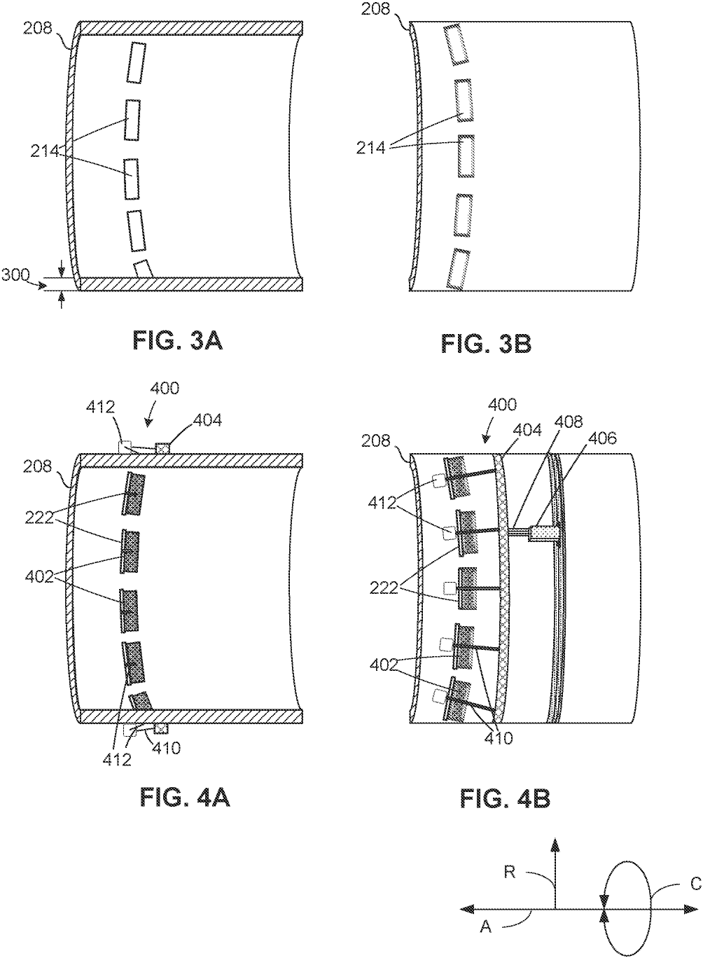

FIGS. 3A and 3B illustrate partial cross-sectional views of a casing (e.g., compressor casing 208) of a turbine engine (e.g., turbofan engine 110 of FIGS. 1 and/or 2) having integrated VBV ports (e.g., VBV ports 214). FIG. 3A illustrates an inner surface of the casing 208, while FIG. 3B illustrates an outer surface of the casing 208. The casing 208 has a thickness 300 defined by a distance from the inner surface of the casing 208 to the outer surface of the casing 208.

The VBV ports 214 extend from the inner surface of the casing 208 to the outer surface of the casing 208. The casing 208 may include one or more VBV ports 214. For example, the casing 208 may include between 8 and 18 VBV ports 214. In some examples, the number of VBV ports 214 integrated into the casing 208 may correspond to a strut count of the turbofan engine 110. In some examples, the VBV port 214 is machined into the casing 208. In some examples, the VBV port 214 is integrated into the casing 208 by an additive manufacturing process. Typically, a VBV assembly is integrated onto the casing 208, which defines a variable bleed valve. Various example VBV assemblies in accordance with the teachings of this disclosure are described in further detail below.

Examples disclosed below are applied to the example compressor 200 of the example turbofan engine 110 as described in FIGS. 2, 3A, and 3B. Accordingly, examples disclosed below include the example casing 208, which defines the mainstream flowpath 212, and the example VBV port(s) 214, which defines the example bleed flowpath 216. Certain examples disclosed below include an example VBV door gap 222. It is understood, however, that examples disclosed herein may be implemented in one or more compressors, such as a high pressure compressor, a low pressure compressor, etc. Further, examples disclosed herein may be implemented on a compressor having a variety of configurations, such as including one or more VBV ports, compressor stages, etc. Further, examples disclosed herein may be applied to a variety of turbine engines, such as a multi-spool turbine engine, a turboshaft engine, turbine engines with one compressor section, etc.

FIGS. 4A and 4B illustrate partial cross-sectional views of the example casing 208 of FIG. 2 and/or FIGS. 3A and 3B, including example VBV ports 214. The casing 208 of FIGS. 4A-4B includes an example VBV assembly 400 structured in accordance with the teachings of this disclosure. The VBV assembly 400 includes a plurality of example VBV doors 402, an example unison ring 404, and an example actuator 406. The example actuator 406 may be a linear actuator, hydraulic actuator, pneumatic actuator, power screw, etc. Any number of VBV doors 402 may be included. For example, the quantity of VBV doors 402 may correspond to the quantity of VBV ports 214 (e.g., from 8 to 24 VBV doors). In some examples, multiple VBV ports 214 may share a VBV door 402. Accordingly, certain examples have a different quantity of VBV doors 402 than VBV ports 214.

The example unison ring 404 and the actuator 406 are positioned radially outward from the casing 208. In the illustrated example of FIGS. 4A and 4B, the VBV assembly 400 is in a closed position. In the closed position, the VBV doors 402 are positioned radially inward relative to the casing 208 and the VBV port 214. As the VBV door 402 transitions from the open position to the closed position (e.g., and vice versa), the VBV door is at least partially within the casing 208 and at least partially outside the casing 208. Accordingly, the casing 208 includes a plurality of VBV door gaps (e.g., VBV door gap 222). The VBV door gaps 222 provide an opening for the VBV doors 402 to slide radially-inward/axially-downstream into the casing 208 (e.g., towards a closed position) and radially-outward/axially-upstream out of the casing 208 (e.g., towards an open position). In some examples, a quantity of VBV door gaps 222 corresponds to the quantity of VBV doors 402. In the open position, the VBV doors 402 are positioned at least partially outside the casing 208. In many such examples, VBV doors 402 may not completely exit the VBV door gap 222. In some examples, the VBV door 402 slides outward from the VBV door gap 222 until a downstream end of the VBV door 402 is flush with a radially inward opening the VBV door gap 222. In some examples, the VBV door 402 may be positioned at 5 percent of its overall stroke in the open position.

In some examples disclosed herein, the example unison ring 404 is utilized to actuate a plurality of VBV doors 402 concurrently. For example, the unison ring 404 may be operatively coupled to the example actuator 406 (e.g., via an example actuator rod 408) and to one or more VBV doors 402 (e.g., via example connection arm(s) 410). As the actuator 406 moves between a first position and a second position, the actuator 406 causes the unison ring 404 to move between the first position and the second position, which in turn causes the VBV doors 402 to move between the first position and the second position. In some examples, the unison ring 404 is operatively coupled to more than one actuator 406. For example, the unison ring 404 may be operatively coupled to a first actuator 406 and a second actuator 406, wherein the second actuator 406 is an additional and/or alternative actuator 406 that may act as a back-up actuator 406. In some examples, an actuator 406 is operatively coupled to more than one unison ring 404.

In some examples, the unison ring 404 may be operatively coupled to the actuator 406 (e.g., via the actuator rod 408) and to an intermediary device(s) (e.g., bell crank, pin-and-slot, etc.) 412 via the example connection arm(s) (e.g., handle, bar, lever, etc.) 410. In such examples, the intermediary device(s) is operatively coupled to the VBV doors 402 (e.g., via example connection arm 410). In other words, the unison ring 404 may be operatively coupled to the intermediary device 412, which is operatively coupled to the VBV door 402. As the actuator 406 moves between the first position and the second position, the unison ring 404 moves between the first position and the second position. The movement of the unison ring 404 between the first position and the second position causes the intermediary device 412 to move between the first position and the second position. The movement of the intermediary device 412 causes the VBV door 402 to move between the first position and the second position. Such an arrangement may enable optimal or otherwise improved placement of components (e.g., VBV doors 402, unison ring 404, actuator 406, intermediary devices 412, etc.) of the VBV assembly 400. Turbine engines are complex pieces of machinery having numerous components working together. Accordingly, examples disclosed herein enable manufacture of a VBV assembly that can be modified to fix a specific turbine engine configuration.

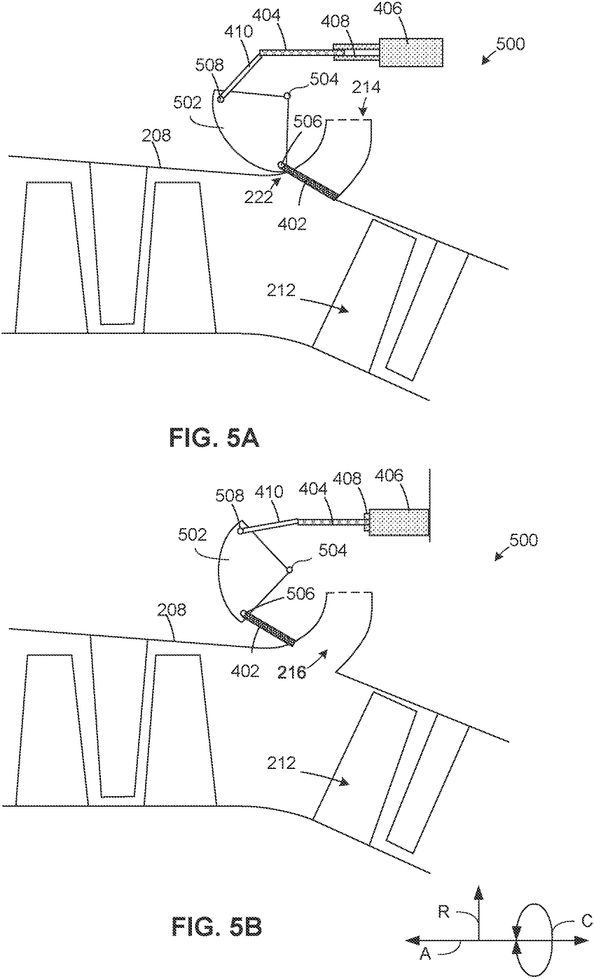

Additional and/or alternative example VBV assemblies are disclosed below. The example VBV assemblies disclosed below are similar to the VBV assembly 400 of FIGS. 4A and 4B. As such, the details of the parts (e.g., casing 208, VBV port(s) 214, VBV door(s) 402, unison ring(s) 404, example actuator(s) 406, etc.) are not repeated in connection with FIGS. 5A-15B. Further, the same reference numbers used for the structures shown in FIGS. 2-4B are used for similar or identical structures in FIGS. 5A-15B. Similar to FIGS. 2-4B, examples below are integrated onto a casing 208 of a LP compressor 202, which defines a mainstream flowpath 212 for airflow through the turbofan engine 110.

FIGS. 5A and 5B illustrate another example VBV assembly 500 structured in accordance with the teachings of this disclosure. The VBV assembly 500 includes at least one example VBV door 402, at least one example VBV door gap 222, and an example actuator 406. The example casing 208 includes at least one VBV port 214 that defines a bleed flowpath 216. The example VBV assembly 500 is a bell crank VBV assembly 500. Accordingly, the VBV assembly 500 of FIGS. 5A and 5B includes an example bell crank 502. The bell crank 502 is an assembly having two linkage points (e.g., each at an end of an arm) connected at a pivot point. The bell crank 502 is structured to change a direction of a force through an angle. For example, an L-shaped bell crank 502 having a 90 degree angle may transmit an axial pulling force on a first arm of the bell crank 502 to a radial pulling force on a second arm by rotating the arms about a pivot point 504. It is understood, however, that the bell crank 502 may be configured with any angle between 0 degrees and 360 degrees. The direction of transmittal of force may vary depending on the angle. In the illustrated example of FIGS. 5A and 5B, the bell crank 502 is positioned radially outward from the example casing 208 and upstream of the example VBV port 214.

The example bell crank 502 includes three example connection points: an example fixed pivot point 504, an example VBV door point 506, and an example actuation point 508. The example fixed pivot point 504 is connected to the turbofan engine 110 such that the bell crank 502 can pivot about the fixed pivot point 504. The fixed pivot point 504 connects the bell crank 502 to the turbofan engine 110 (FIG. 1). The fixed pivot point 504 may be connected to the turbofan engine 110 using a stationary connection point of the turbofan engine 110, such as a wall extending radially outward from the casing 208, etc. An upstream end of the VBV door 402 is operatively coupled to the VBV door point 506 of the bell crank 502. In the illustrated example of FIGS. 5A and 5B, the actuation point 508 of the bell and crank 502 is operatively coupled to an example unison ring 404 via example connection arm 410. The example unison ring 404 is operatively coupled to an example actuator 406 via example actuator rod 408.

In operation, the actuator 406 moves between a first position (e.g., a closed position of FIG. 5A whereby airflow is blocked from entering the VBV port 214) and a second position (e.g., an open position of FIG. 5B whereby airflow can move into the VBV port 214). In the illustrated example of FIGS. 5A and 5B, the actuator 406 moves in an axial direction. However, the actuator 406 may be configured to move in other direction(s) capable of causing the VBV assembly 500 to open and/or close the VBV port 214. The movement of the actuator 406 from the first position to the second position causes the unison ring 404 to move from the first position to the second position. The movement of the unison ring 404 from the first position to the second position pulls the bell crank 502 via the connection arm 410, during which the bell crank 502 pivots about the fixed pivot point 504. As the bell crank 502 pivots, the bell crank 502 pulls the VBV door 402 from the first (closed) position to the second (open) position. In other words, the unison ring 404 causes the bell crank 502 to pivot about the fixed pivot point 504. To move towards an open position, the VBV door slides radially-outward/axially-upstream from the VBV door gap 222.

To move the VBV assembly 500 to the first position, the actuator 406 moves from the second position to the first position, which causes the unison ring 404 to move from the second position to the first position. The movement of the unison ring 404 from the second position to the first position pushes the connection arm 410, which causes the bell crank 502 to pivot about the fixed pivot point 504 causing a pushing force on the VBV door 402. The force on the VBV door 402 causes the VBV door 402 to slide through the VBV door gap 222 towards the first (closed) position. While moving towards the closed position, the VBV door 402 moves in a radially-inward/axially-downstream direction. In operation, the VBV assembly 500 may be moved towards a partially-open position and/or a partially-closed position. That is, the VBV doors 402 may be actuated to be partially open and/or partially closed.

The VBV assembly 500 of FIGS. 5A and 5B can be configured in a variety of arrangements. In some examples, the unison ring 404 operatively and circumferentially links every bell crank 502 (and corresponding VBV door 402) of the VBV assembly 500. In such examples, a single actuator 406 causes the single unison ring 404 to move each VBV door 402 of the VBV assembly 500 concurrently. In some examples, the VBV assembly 500 includes more than one unison ring 404, each unison ring 404 having a corresponding actuator 406. In such examples, each unison ring 404 may operatively and circumferentially link a plurality of bell cranks 502 (and corresponding VBV doors 402). In other words, some examples enable a subset of bell cranks 502 and corresponding VBV doors 402 to be linked and actuated via distinct unison rings 404.

In some examples, the VBV assembly 500 does not include a unison ring 404. In such examples, each bell and crank 502 is operatively coupled to a corresponding actuator 406, which pushes and/or pulls the bell crank 502 to cause the bell crank 502 to pivot about the fixed pivot point 504. In some examples, the bell cranks 502 are operatively coupled to the actuators 406 via corresponding connection arms 410.

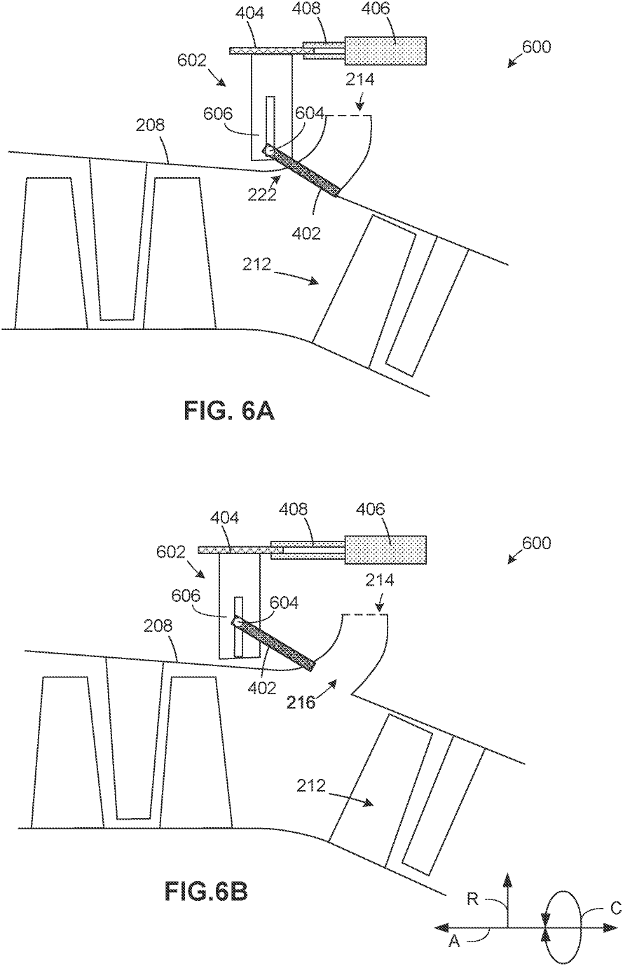

FIGS. 6A and 6B illustrate another example VBV assembly 600 structured in accordance with the teachings of this disclosure. The VBV assembly 600 includes at least one example VBV door 402, at least one example VBV door gap 222, and an example actuator 406. The example casing 208 includes at least one VBV port 214 that defines a bleed flowpath 216. The example VBV assembly 600 is a pin-and-slot VBV assembly 600. Accordingly, the VBV assembly 600 of FIGS. 6A and 6B include an example pin-and-slot 602, which includes an example slider pin 604 and an example slot 606. In the illustrated example of FIGS. 6A and 6B, the pin-and-slot 602 is positioned radially outward from the example casing 208 and upstream of the example VBV port 214. The slider pin 604 rests within the slot 606 but is not coupled to the slot 606. The slot 606 is coupled to the turbofan engine 110.

An upstream end of the VBV door 402 is operatively coupled to the pin-and-slot 602 via the slider pin 604. The example pin-and-slot 602 is connected to an example actuator 406 such that the pin-and-slot 602 can move back-and-forth in an axial direction (e.g., upstream and downstream). In the illustrated example of FIGS. 6A and 6B, the pin-and-slot 602 is operatively coupled to an example unison ring 404. The example unison ring 404 is operatively coupled to an example actuator 406 via an example actuator rod 408.

In operation, the actuator 406 moves between a first position (e.g., a closed position of FIG. 6A) and a second position (e.g., an open position of FIG. 6B). In the illustrated example of FIGS. 6A and 6B, the actuator 406 moves in an axial direction. However, the actuator 406 may be configured to move in other direction(s) capable of causing the VBV assembly 600 to open and/or close the VBV port 214. The movement of the actuator 406 from the first position to the second position causes the unison ring 404 to move from the first position to the second position in the axial direction. The movement of the unison ring 404 from the first position to the second position causes the slot 606 to move from the first position to the second position in the axial direction, which causes the slider pin 604 to slide up the slot 606. The movement of the slider pin 604 sliding up the slot 606 causes the VBV door 402 to move in a radially-outward/axially-upstream direction out of the VBV door gap 222 and towards the second (e.g., open) position. In other words, the unison ring 404 causes the pin-and-slot 602 to pull the VBV door 402 out of the VBV door gap 222.

To move the VBV assembly 600 to the first position, the actuator 406 moves from the second position to the first position, which causes the unison ring 404 to move from the second position to the first position. The movement of the unison ring 404 from the second position to the first position causes the slot 606 to move from the second position to the first position causing the slider pin 604 to slide down the slot 606. A resultant pushing force on the VBV door 402 causes the VBV door 402 to slide into the VBV door gap 222 towards the first (closed) position. While moving towards the closed position, the VBV door 402 moves in a radially-inward/axially-downstream component direction.

The VBV assembly 600 of FIGS. 6A and 6B can be configured in a variety of arrangements. In some examples, a different pin-and-slot mechanisms is utilized which may rely on differing forces and angles. In some examples, the unison ring 404 operatively and circumferentially links every pin-and-slot 602 (and corresponding VBV door 402). In such examples, at least one actuator 406 may cause the single unison ring 404 to move every VBV door 402 of the VBV assembly 600 concurrently. In some examples, the VBV assembly 600 includes more than one unison ring 404, each unison ring 404 having a corresponding actuator 406. In such examples, each unison ring 404 may operatively and circumferentially link a plurality of pin-and-slots 602 (and corresponding VBV doors 402). In other words, some examples enable a subset of pin-and-slots 602 and corresponding VBV doors 402 to be linked and actuated via distinct unison rings 404.

In some examples, the VBV assembly 600 does not include a unison ring 404. In such examples, each pin-and-slot 602 is operatively coupled to a corresponding actuator 406, which pushes and/or pulls the slot 606 to cause the slider pin 604 to slide up and/or down the slot 606.

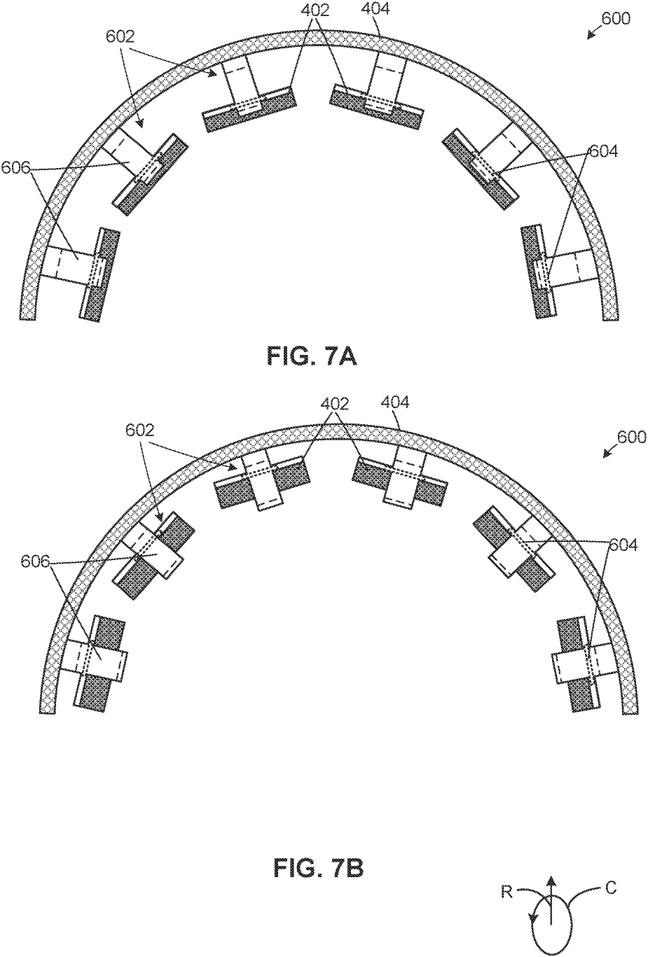

FIGS. 7A and 7B illustrate a partial circumferential view of the example VBV assembly 600 of FIGS. 6A and 6B. FIGS. 7A and 7B also illustrate an example unison ring 404 that may be used by example VBV assemblies disclosed herein, such as the VBV assembly 500 of FIGS. 5A and 5B. FIGS. 7A and 7B illustrate a plurality of pin-and-slots 602 that are circumferentially and operatively coupled to the unison ring 404. While example slider pins 604 and example slots 606 may not be viewable, the slider pins 604 and slots 606 are depicted in FIGS. 7A and 7B. Each VBV door 402 illustrated in FIGS. 7A and 7B are operatively coupled to a respective slider pin 604.

FIG. 7A illustrates the example VBV assembly 600 in a closed position. In the closed position, the unison ring 404 is axially downstream relative to the unison ring 404 in an open position. The slider pin 604 is located radially inward within the slot 606. In operation, the actuator 406 (not illustrated in FIGS. 7A and 7B) pushes the unison ring 404 radially upstream to move the unison ring 404 from the closed position to the open position. Such movement causes the slider pin 604 to slide radially outward along the slot 606, pulling the VBV door 402 radially-outward/axially-upstream out of an example VBV door gap (not pictured). The VBV door 402 changes an angle as it transitions between the open position and the closed position and vice versa.

FIG. 7B illustrates the example VBV assembly 600 in an open position. The slider pin 604 in located radially outward in the slot 606. In the open position, the unison ring 404 is upstream relative to the unison ring 404 in the closed position. In operation, the actuator 406 (not illustrated in FIGS. 7A and 7B) pulls the unison ring 404 radially downstream to move the unison ring 404 from the open position to the closed position. Such movement causes the slider pin 604 to slide radially inward along the slot 606, pushing the VBV door 402 radially-inward/axially-downstream into the example VBV door gap.

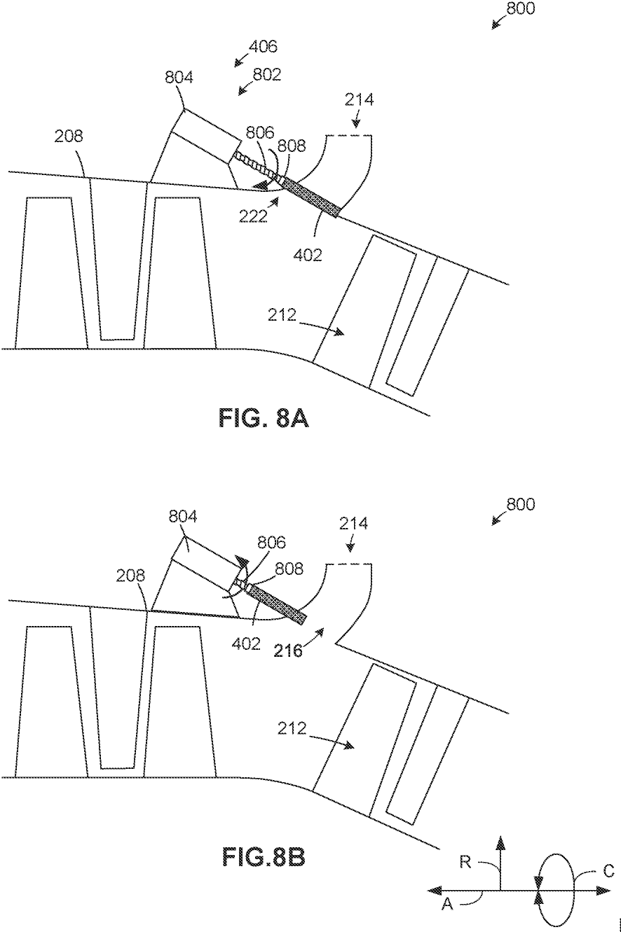

FIGS. 8A and 8B illustrate another example VBV assembly 800 structured in accordance with the teachings of this disclosure. The VBV assembly 800 includes an example VBV door 402, an example VBV door gap 222, and an example actuator 406. The example casing 208 includes a VBV port 214 that defines a bleed flowpath 216. The example VBV assembly 800 is a power screw VBV assembly 800. Accordingly, the actuator 406 of the VBV assembly 800 of FIGS. 8A and 8B is an example power screw (e.g., lead screw) 802. The power screw 802 is structured to translate a turning motion into a linear motion. In the illustrated example of FIGS. 8A and 8B, the power screw 802 is positioned radially outward from the example casing 208. The power screw 802, which is positioned upstream of the VBV port 214, provides the actuation to move the VBV door 402 between an open position and a closed position. Accordingly, actuation occurs upstream of the VBV port 214. The power screw 802 rotates circumferentially but does not move axially.

The example power screw 802 includes an example motor 804, an example screw shaft 806 having a thread, and an example nut 808. The motor 804 is coupled to the turbofan engine 110. In the illustrated example of FIGS. 8A and 8B, the screw shaft 806 is operatively connected to the motor 804 at a first end with a bearing. The screw shaft 806 is operatively coupled to the example nut 808 at a second end. The nut 808 is coupled to the VBV door 402, which includes an aperture to receive the screw shaft 806.

In operation, the motor 804 provides a rotating motion which causes the screw shaft 806 to rotate. The rotation of the screw shaft 806 causes the nut 808 to move along the screw shaft 806. The direction that the nut 808 moves depends on the direction of rotation of the screw shaft 806. Because the nut 808 is coupled to the VBV door 402, the movement of the nut 808 causes movement of the VBV door 402.

The motor 804 spins a first direction, causing the screw shaft 806 to rotate a first direction, causing the nut 808 to move from a first position (e.g., a closed position of FIG. 8A) to a second position (e.g., an open position of FIG. 8B). The movement of the nut 808 from the first position to the second position causes the VBV door 402 to move from the first (e.g. closed) position to the second (e.g., open) position. In the first position, the screw shaft 806 is at least partially within the VBV door 402. Accordingly, as the VBV door 402 moves from the first and second position, the screw shaft 806 moves outward from the VBV door 402. To move towards an open position, the VBV door 402 slides outwards from the VBV door gap 222. In the illustrated example of FIGS. 8A and 8B, the nut 808 and VBV door 402 moves in an axial-radial direction.

To move the VBV assembly 800 to the first position, the motor spins a second direction, causing the screw shaft 806 to rotate the second direction, causing the nut 808 to move from the second position to the first position. The movement of the nut 808 from the second position to the first position causes the VBV door 402 to move from the second position to the first position. As the VBV door 402 moves from the second position and the first position, the screw shaft 806 moves into the VBV door 402.

The VBV assembly 800 of FIGS. 8A and 8B can be configured in a variety of arrangements. For example, a variety of power screw/lead screw 802 can be used to provide a force that opens and/or closes the VBV door 402 during operation of the turbofan engine 110. Further, the power screw 802 can have a variety of configurations, including with a variety of motors 804 that cause a rotation, any type of screw shaft 806, etc.

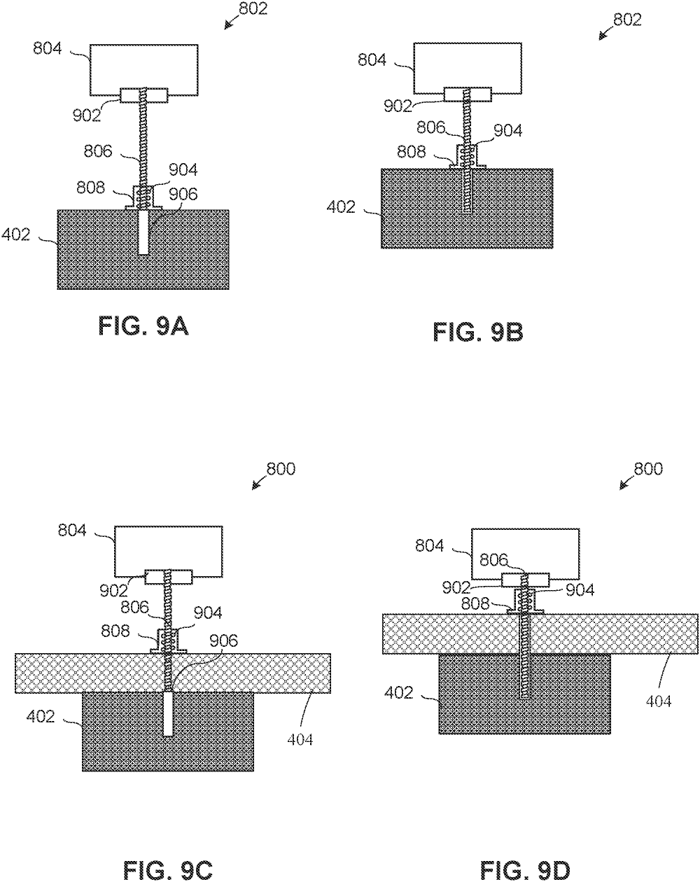

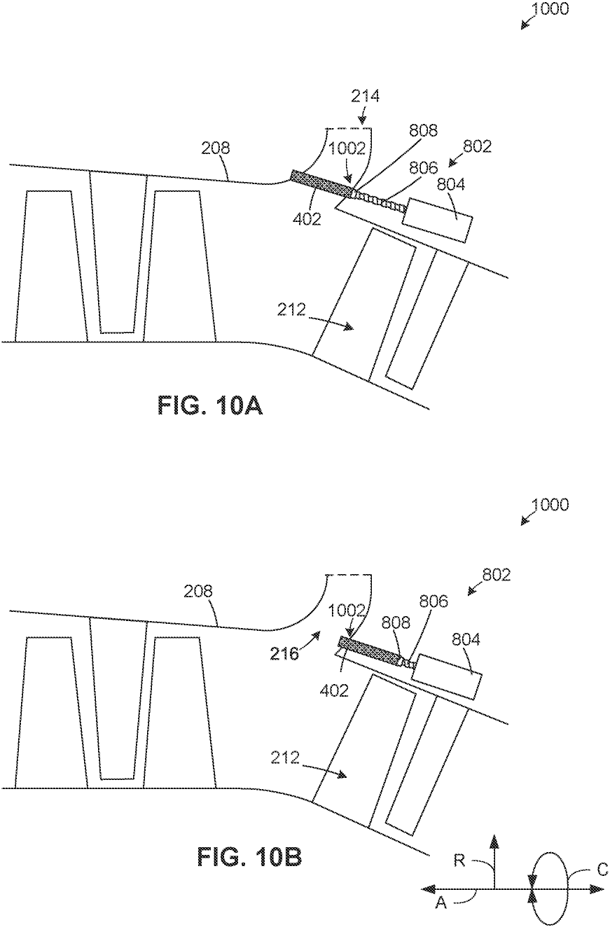

FIGS. 9A and 9B illustrate an example power screw (e.g., power screw 802 of FIGS. 8A, 8B, 10A, 10B, etc.) including an example motor 804, an example screw shaft 806, and an example nut 808. FIGS. 9A and 9B also illustrate an example bearing 902. The bearing 902 provides support for a radial load (e.g., from the nut 808, VBV door 402, etc.) as well as an axial load (e.g., from the nut 808, VBV door 402, etc.) while reducing friction between components.

FIGS. 9A and 9B also illustrate example ball screws 904 within the nut 808. The ball screws convert rotational motion of the screw shaft 806 into linear motion (e.g., of the nut 808). As the screw shaft 806 rotates, the ball screws 904 enable the nut 808 to move along the screw shaft 806.

FIGS. 9A and 9B also illustrate an example floating bearing 906 positioned within the VBV door 402. The floating bearing 906 allows the screw shaft 806 to move into and/or out of the VBV door 402 without rotating the VBV door 402. Further, the floating bearing 906 allows the screw shaft 806 to rotate freely within the VBV door 402 without putting a force on the VBV door 402. The force on the VBV door 402 is applied by the nut 808.

FIG. 9A illustrates the power screw 802 when the VBV assembly 800 is in a closed position. To move the VBV assembly 800 into an open position, the motor 804 causes the screw shaft 806 to rotate. The rotation of the screw shaft 806 causes the ball screws 904 to move along the screw shaft 806, which causes the VBV door 402 to move along the screw shaft 806. The screw shaft 806 enters the floating bearing 906 within the VBV door 402.

FIG. 9B illustrates an example view of the power screw 802 when the VBV assembly 800 is in the open position. As illustrated in FIG. 9B, the screw shaft 806 is within the floating bearing 906 of the VBV door 402. To move the VBV assembly 800 into the closed position, the motor 804 causes the screw shaft 806 to rotate (e.g., in a direction opposite the rotation that causes the VBV assembly to move into the open position). The rotation of the screw shaft 806 causes the ball screws 904 to move along the screw shaft 806, which causes the VBV door 402 to move along the screw shaft 806. The screw shaft 806 emerges from the floating bearing 906 within the VBV door 402 as the VBV door 402 moves along the screw shaft 806.

FIGS. 9C and 9D illustrate the VBV assembly 800 of FIGS. 8A and 8B with an example unison ring 404. The illustrated examples of 9C and 9D operate in a similar manner as described in FIGS. 8A, 8B, 9A, and 9B except that the nut 808 is coupled to the unison ring 404 as opposed to the VBV door 402. The VBV door 402 is attached to the unison ring 404.

FIGS. 10A and 10B illustrate another example VBV assembly 1000 structured in accordance with the teachings of this disclosure. The example casing 208 includes a VBV port 214 that defines a bleed flowpath 216. The VBV assembly 1000 an example VBV door 402, an example VBV door gap 1002, and an example actuator 406. The VBV assembly 1000 of FIGS. 10A and 10B utilize an example power screw (e.g., power screw 802) as the actuator. Accordingly, VBV assembly 1000 is similar to the VBV assembly 800 of FIGS. 8A-8B and 9A-9B. However, unlike the VBV door gaps 222 of FIGS. 2-8, the VBV door gap 1002 is located aft of the VBV port 214. Further, actuation of the VBV door 402 occurs aft of the VBV port 214 in FIGS. 10A and 10B. During operation, the VBV assembly 1000 operates similar to the VBV assembly 800 of FIGS. 8A-8B and 9A-9B. Actual actuation of the VBV assembly 1000 may vary depending on a configuration of the VBV assembly 1000 in terms of components used (e.g., type of power screw 802, etc.) and in terms of positions of the components (e.g., angle of power screw 802, etc.).

Similar to the differences of VBV assembly 1000 of FIGS. 10A and 10B and VBV assembly 800 of FIGS. 8A-8B and 9A-9B, the VBV assemblies 400, 500, 600 of FIGS. 4A-4B, 5A-5B, and 6A-6B can be configured to actuate downstream of the VBV port 214. For example, the VBV door gaps 222 can be replaced by VBV door gaps 1002. Further, the unison ring(s) 404 and actuator(s) 406 may be positioned downstream of the VBV port 214. In such examples, the VBV door 402 moves radially-inward/axially-downstream when moving into an open position. In such examples, the VBV door 402 moves radially-outward/axially-upstream when moving into a closed position.

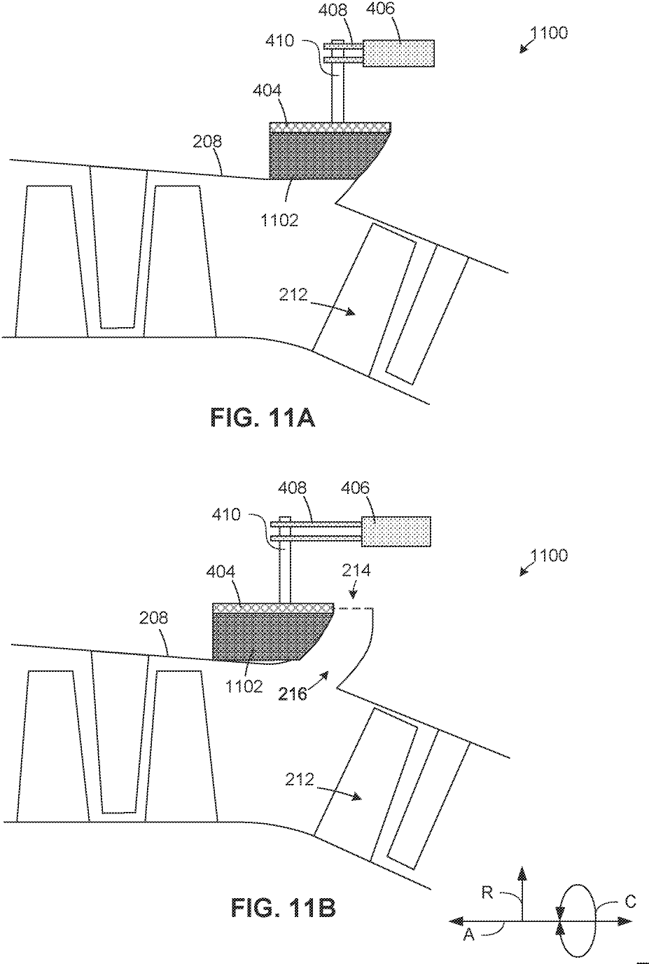

FIGS. 11A and 11B illustrate another example VBV assembly 1100 structured in accordance with the teachings of this disclosure. The casing 208 includes at least one VBV port 214 that defines a bleed flowpath 216. The VBV assembly 1100 includes an example unison ring 404 and an example actuator 406. An example VBV wall 1102 acts as a VBV door 402. The VBV wall 1102 is coupled to the unison ring 404. The unison ring 404 and the VBV wall 1102 act as the variable bleed valve. In the illustrated example of FIGS. 11A and 11B, the unison ring 404 and the VBV wall 1102 combination is positioned radially outward from the example casing 208 and upstream of the example VBV port 214.

The unison ring 404 is coupled to an example connection arm 410, which is operatively coupled to the example actuator 406 via example actuator rod 408. In operation, the actuator 406 moves between a first position (e.g., a closed position of FIG. 11A) and a second position (e.g., an open position of FIG. 11B). In the illustrated example of FIGS. 11A and 11B, the actuator 406 moves in an axial direction. However, the actuator 406 may be configured to move in one or more other direction(s) capable of causing the VBV assembly 1100 to open and/or close the VBV port 214. The movement of the actuator 406 from the first position to the second position causes the unison ring 404 to move from the first position to the second position (e.g., via the actuator rod 408 and the connection arm 410). The movement of the unison ring 404 from the first position to the second position causes the VBV wall 1102 to move from the first (closed) position to the second (open) position. To move towards an open position, the VBV wall 1102 moves in an upstream/axial direction.

To move the VBV assembly 1100 to the first position, the actuator 406 moves from the second position to the first position, which causes the unison ring 404 to move from the second position to the first position. The movement of the unison ring 404 from the second position to the first position causes the VBV wall 1102 to move towards the first (closed) position. While moving towards a closed position, the VBV wall 1102 moves in a downstream/axial direction.

The VBV assembly 1100 of FIGS. 11A and 11B can be configured in a variety of arrangements. In some examples, the unison ring 404 operatively and circumferentially links a plurality of VBV walls 1102. In such examples, a single actuator 406 causes the single unison ring 404 to move every VBV wall 1102 of the VBV assembly 1100 concurrently. In some examples, the VBV assembly 1100 includes more than one unison ring 404, each unison ring 404 having a corresponding actuator 406. In such examples, each unison ring 404 may operatively and circumferentially link a plurality of VBV walls 1102. In other words, some examples enable a subset of VBV walls 1102 to be linked and actuated via distinct unison rings 404.

In some examples, the VBV wall 1102 is defined by a circumferential substrate that acts as a VBV door for a plurality of VBV ports 214. In such examples, the VBV wall 1102 may be integrally formed with the unison ring 404. In some examples, a unison ring 404 may not be included. In such examples, the VBV wall 1102 may be operatively coupled to the actuator 406.

In the illustrated example of FIGS. 11A and 11B, the VBV assembly 1100 translates motion via a VBV wall 1102 of the bleed flowpath 216. In examples disclosed above, the VBV assemblies 400, 500, 600, 800, 1000 translated motion at the entrance of the VBV port 214 from the compressor 200. Accordingly, the VBV assembly 1100 of FIGS. 11A and 11B utilize the VBV wall 1102 to define the VBV port 214. In some examples, the VBV assembly 1100 may not eliminate a bleed cavity 220. However, some examples reduce a volume of the bleed cavity 220.

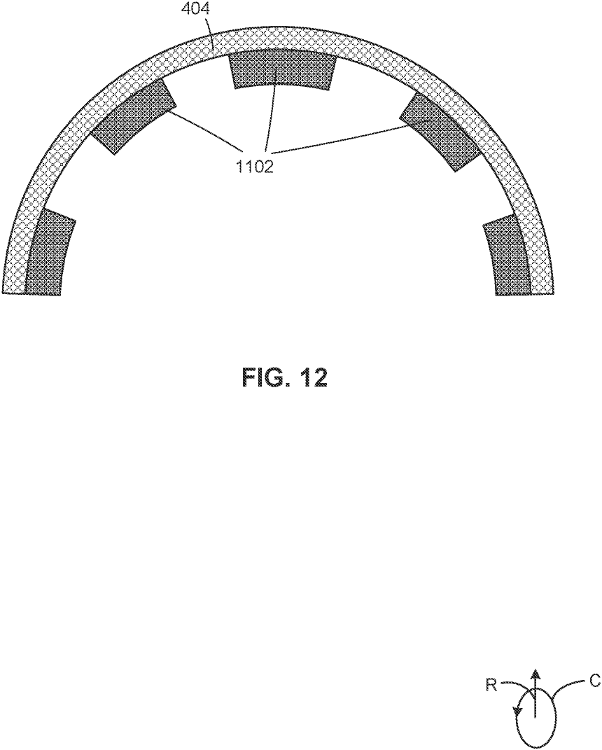

FIG. 12 is a partial cross-sectional view of the VBV assembly 1100 of FIGS. 11A and/or 11B. The VBV walls 1102 are coupled to the unison ring 404. The unison ring 404 ring is operatively coupled to the actuator 406 (not shown in FIG. 12). The movement of the actuator 406, the unison ring 404, and the VBV walls 1102 in the illustrated example of FIG. 12 is axial. The movement is downstream when moving to a closed position and upstream when moving to an open position. However, the movement of the actuator 406, the unison ring, and/or the VBV walls 1102 may be in any suitable direction to enable the VBV port 214 to open and/or close during operation of the turbofan engine 110. In some examples, a quantity of VBV walls 1102 corresponds to a quantity of VBV ports 214. In some examples, the VBV wall 1102 extends circumferentially around the casing 208 to move between first and second positions with reference to each VBV port 214 of the casing 208 (e.g., to open and/or close each VBV port 214) concurrently. In some examples, the VBV wall 1102 extends partially around the casing 208 to move between first and second positions in relation a plurality of VBV ports 214 that is less than all the VBV ports 214, enabling a subset of VBV ports 214 to be opened and/or closed concurrently.

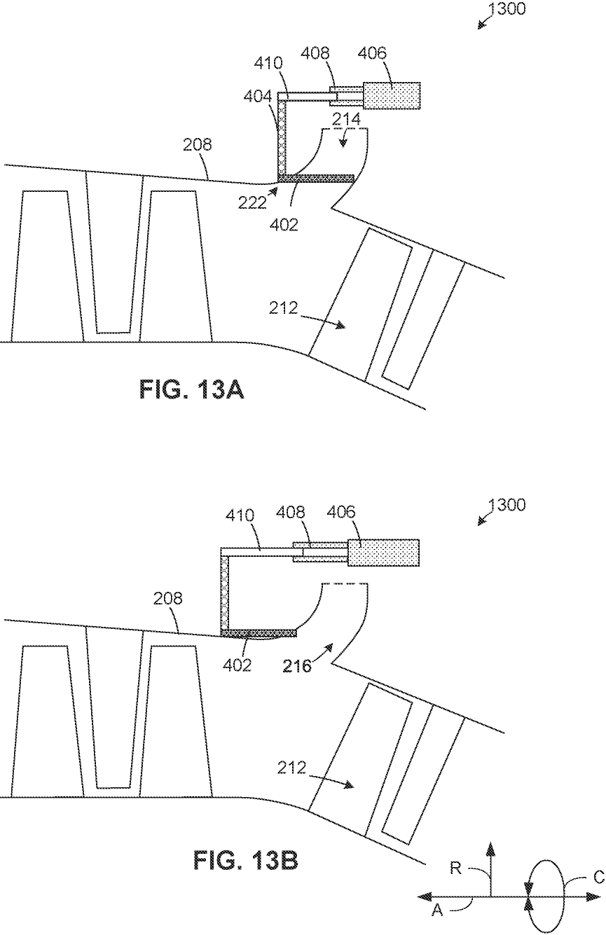

FIGS. 13A and 13B illustrate another example VBV assembly 1300 structured in accordance with the teachings of this disclosure. The casing 208 includes at least one VBV port 214 that defines a bleed flowpath 216. The VBV assembly 1300 includes at least one example VBV door 402, at least one example VBV door gap 222, and an example actuator 406. In the illustrated example of FIGS. 13A and 13B, an upstream end of the VBV door 402 is coupled to the unison ring 404. The unison ring 404 is positioned radially outward from the example casing 208 and upstream of the example VBV port 214. The example unison ring 404 is coupled to an example connection arm 410, which is operatively coupled to the actuator 406 via an example actuator rod 408. In the illustrated example of FIGS. 13A and 13B, the connection arm 410 is defined by a circumferential substrate.

In operation, the actuator 406 moves between a first position (e.g., a closed position of FIG. 13A) and a second position (e.g., an open position of FIG. 13B). In the illustrated example of FIGS. 13A and 13B, the actuator 406, unison ring 404, and VBV door 402 moves in an axial direction. However, the actuator 406 may be configured to move in one or more other directions capable of causing the VBV assembly 1300 to open and/or close the VBV port 214.

The movement of the actuator 406 from the first position to the second position causes the unison ring 404 to move from the first position to the second position (e.g., via an actuator rod 408, etc.). The movement of the unison ring 404 from the first position to the second position causes the VBV door(s) 402 to move from the first (closed) position to the second (open) position. To move towards the open position, the VBV door 402 slides in an axial-upstream direction from the VBV door gap 222.

To move the VBV assembly 1300 to the first position, the actuator 406 moves from the second position to the first position, which causes the unison ring 404 to move from the second position to the first position. The movement of the unison ring 404 from the second position to the first position causes the VBV door(s) 402 to move towards the first (closed) position. While moving towards a closed position, the VBV door(s) 402 moves in a downstream/axial direction.

The VBV assembly 1300 of FIGS. 13A and 13B may be configured in a variety of arrangements. In some examples, the unison ring 404 operatively and circumferentially links every VBV door 402 of the VBV assembly 1300. In such examples, a single actuator 406 causes the single unison ring 404 to move every VBV door 402 of the VBV assembly 1300 concurrently. In some examples, the VBV assembly 1300 includes more than one unison ring 404, each unison ring 404 having a corresponding actuator 406. In such examples, each unison ring 404 may operatively and circumferentially link a plurality of VBV doors 402. In other words, some examples enable a subset of VBV doors 402 to be linked and actuated via distinct unison rings 404.

In some examples, the VBV assembly 1300 does not include a unison ring 404. In such examples, each VBV door 402 is operatively coupled to a corresponding actuator 406, which pushes and/or pulls an example connection arm (e.g., connection arm 410) to cause the VBV door 402 move between positions. In some examples, the VBV doors 402 are operatively coupled to the actuators 406 via corresponding connection arms 410.

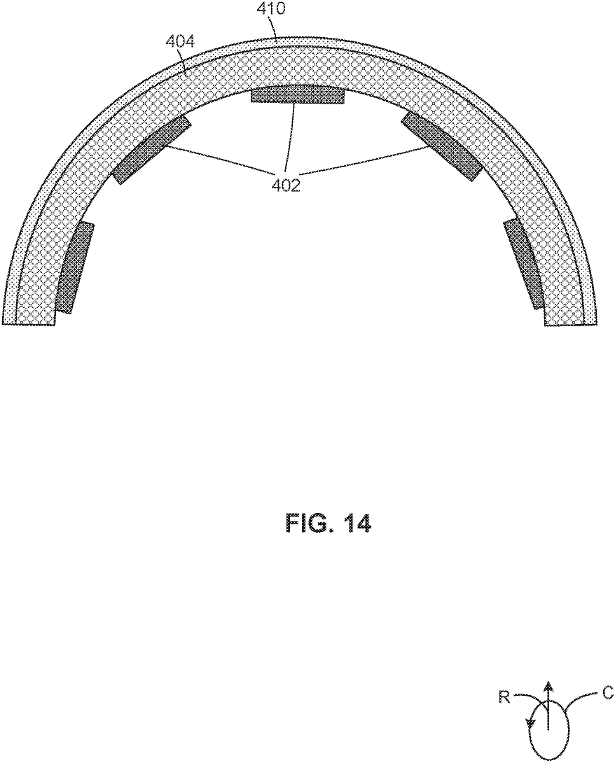

FIG. 14 is a partial cross-sectional view of the VBV assembly 1300 of FIGS. 13A and/or 13B. FIG. 14 illustrates the unison ring 404, which is connected to the VBV doors 402 at a first end and to the connection arm 410 at a second end. The connection arm 410 is operatively coupled to the actuator 406 (not shown in FIG. 12). The movement of the actuator 406, the unison ring 404, and the VBV walls 1102 in the illustrated example of FIG. 12 is purely axial. The movement is downstream when moving to a closed position and upstream when moving to an open position. However, the movement of the actuator 406, the unison ring, and/or the VBV walls 1102 may be in any suitable direction to enable the VBV port 214 to open and/or close during operation of the turbofan engine 110 (FIG. 1).

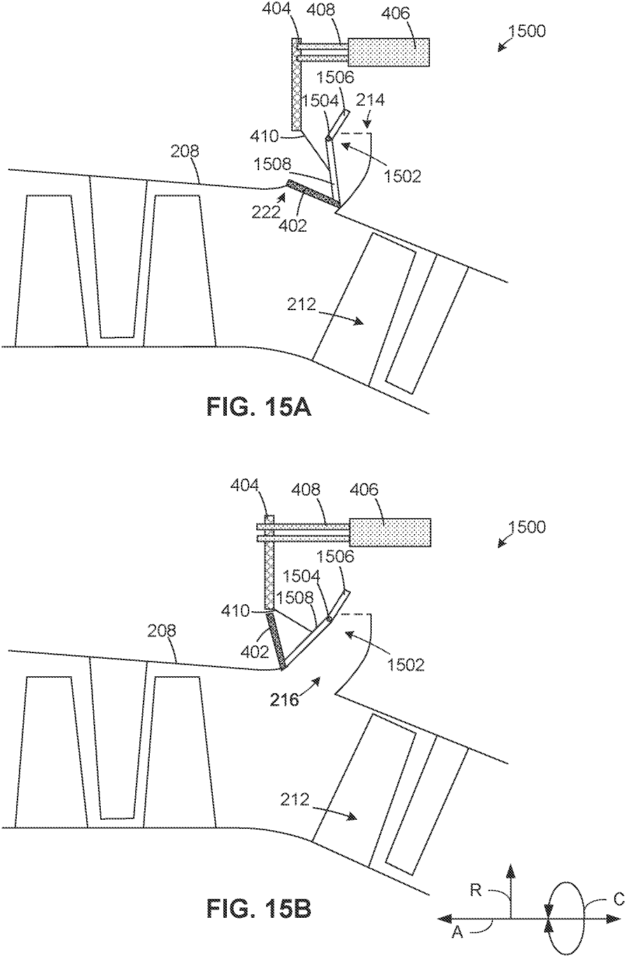

FIGS. 15A and 15B illustrate another example VBV assembly 1500 structured in accordance with the teachings of this disclosure. The VBV assembly 1500 includes at least one example VBV door 402, an example unison ring 404, and an example actuator 406. The example casing 208 includes at least one VBV port 214 that at least partially defines a bleed flowpath 216. The example VBV assembly 1500 is a hinge VBV assembly 1500. Accordingly, the VBV assembly 1500 of FIGS. 15A and 15B includes an example hinge 1502. In the illustrated example of FIGS. 15A and 15B, the hinge 1502 is positioned radially outward from the example casing 208 and the example VBV port 214.

The hinge 1502 is structured to move the VBV door 402 about an example hinge point 1504. The hinge 1502 includes an example stationary leaf 1506 and an example mobile leaf 1508 connected at the hinge point 1504. The example stationary leaf 1506 is coupled to the turbofan engine 110 at the bleed flowpath 216. The hinge point 1504 connects the stationary leaf 1506 and the mobile leaf 1508 in such a manner that allows the mobile leaf 1508 to pivot about the hinge point 1504. A downstream end of the VBV door 402 is coupled to the mobile leaf 1508. In the illustrated example of FIGS. 15A and 15B, the mobile leaf 1508 is operatively coupled to the unison ring 404 via an example connection arm 410. The unison ring 404 is operatively coupled to the actuator 406 via example actuator rod 408.

In operation, the actuator 406 moves between a first position (e.g., a closed position of FIG. 15A) and a second position (e.g., an open position of FIG. 15B). In the illustrated example of FIGS. 15A and 15B, the actuator 406 moves in an axial direction. However, the actuator 406 may be configured to move in one or more other directions capable of causing the VBV assembly 1500 to open and/or close the VBV port 214. The movement of the actuator 406 from the first position to the second position causes the unison ring 404 to move from the first position to the second position. The movement of the unison ring 404 from the first position to the second position pulls the mobile leaf 1508 via the example connection arm 410, during which the mobile leaf 1508 pivots about the hinge point 1504. As the mobile leaf 1508 pivots about the hinge point 1504, the mobile leaf 1508 pulls the VBV door 402 from the first (closed) position to the second (open) position. In other words, the unison ring 404 causes the mobile leaf 1508 to pivot about the hinge point 1504 which causes a circumferential motion of the VBV door 402. The circumferential motion of the VBV door 402 moves the VBV door 402 from the first position to the second position.

To move the VBV assembly 1500 to the first position, the actuator 406 moves from the second position to the first position, which causes the unison ring 404 to move from the second position to the first position. The movement of the unison ring 404 from the second position to the first position pushes the connection arm 410, which causes the mobile leaf 1508 to pivot about the hinge point 1504. The motion of the mobile leaf 1508 as it pivots about the hinge point 1504 causes the VBV door 402 to move in a circumferential motion towards the first (closed) position. That is, to move towards the closed position, the VBV door 402 moves circumferentially (e.g. rotates) about the hinge point 1504. In the closed position, the mobile leaf 1508 acts as a VBV port 214 wall.

The VBV assembly 1500 of FIGS. 15A and 15B can be configured in a variety of arrangements. In some examples, the unison ring 404 operatively and circumferentially links every hinge 1502 (and corresponding VBV door 402) of the VBV assembly 1500. In such examples, a single actuator 406 causes the single unison ring 404 to move every VBV door 402 of the VBV assembly 1500 concurrently. In some examples, the VBV assembly 1500 includes more than one unison ring 404, each unison ring 404 having a corresponding actuator 406. In such examples, each unison ring 404 may operatively and circumferentially link a plurality of hinges 1502 (and corresponding VBV doors 402). In other words, some examples enable a subset of hinges 1502 and corresponding VBV doors 402 to be linked and actuated via distinct unison rings 404.

In some examples, the VBV assembly 1500 does not include a unison ring 404. In such examples, each hinge 1502 is operatively coupled to a corresponding actuator 406, which pushes and/or pulls the mobile leaf 1508 about the hinge point 1504. In some examples, the hinges 1502 are operatively coupled to the actuators 406 via corresponding connection arms 410.

Example VBV assemblies 400, 500, 600, 800, 1000, 1100, 1300, 1500 disclosed above have a variety of features. In some examples, a sliding door (e.g., VBV door 402) is used to open and/or close a VBV port 214. In some examples, the VBV door 402 slides through a VBV door gap 222, 1002. In some examples, the VBV door 402 is flush with a casing 208 in a closed position. Accordingly, some examples close off a bleed cavity 220 in a closed position. The VBV door 402 may move in various directions (e.g., axially, radially, circumferentially, axially-radially, etc.). In some examples, a hinge is used to move the VBV door 402 (e.g., circumferentially about a hinge point connected at a secondary flowpath). Some examples enable a VBV assembly 400, 500, 600, 800, 1000, 1100, 1300, 1500 to move a sub-set of VBV doors 402 between the open position and closed position.

Although each example VBV assembly 400, 500, 600, 800, 1000, 1100, 1300, 1500 disclosed above has certain features, it should be understood that it is not necessary for a particular feature of one example VBV assembly 400, 500, 600, 800, 1000, 1100, 1300, 1500 to be used exclusively with that example. Instead, any of the features described above and/or depicted in the drawings can be combined with any of the examples, in addition to or in substitution for any of the other features of those examples. One example’s features are not mutually exclusive to another example’s features. Instead, the scope of this disclosure encompasses any combination of any of the features. Features of the example VBV assemblies 400, 500, 600, 800, 1000, 1100, 1300, 1500 disclosed above may be combined, divided, re-arranged, omitted, eliminated, and/or implemented in any other way.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, apparatus, and articles of manufacture have been disclosed that enable manufacture of an advantageous VBV assembly. Examples disclosed herein enable actuation of a VBV door that is flush with a casing in a closed position thereby eliminating a bleed cavity. Examples disclosed herein enable actuation of a VBV door that limits an impact of the bleed cavity on mainstream airflow. Examples disclosed herein enable manufacture of a variety of VBV assemblies that may be configured according to a specific turbine engine. Accordingly, examples disclosed herein enable improved operability and efficiency of a turbine engine, enable aerodynamic benefits, and improve stall margin.

Further aspects of the present disclosure are provided by the subject matter of the following clauses:

Example 1 includes an apparatus comprising a variable bleed valve (VBV) door corresponding to a bleed port, an intermediary device operatively coupled to the VBV door, and a first actuator operatively coupled to the intermediary device, the first actuator to move between a first position and a second position, the first actuator to cause the intermediary device to move between the first position and the second position to cause the VBV door to move between the first position and the second position.

Example 2 includes the apparatus of any preceding clause, wherein the VBV door slides between the first position and the second position.

Example 3 includes the apparatus of any preceding clause, wherein the first position is a closed position and the second position is an open position.

Example 4 includes the apparatus of any preceding clause, wherein the VBV door is substantially flush with a flow path in the first position.

Example 5 includes the apparatus of any preceding clause, further including a plurality of VBV doors corresponding a plurality of bleed ports, the plurality of VBV doors spaced circumferentially apart.

Example 6 includes the apparatus of any preceding clause, wherein each of the plurality of VBV doors are positioned forward or aft of respective ones of the plurality of bleed ports in the second position.

Example 7 includes the apparatus of any preceding clause, further including a plurality of intermediary devices corresponding to the plurality of VBV doors, ones of the plurality of intermediary devices operatively coupled to respective ones of the VBV doors.

Example 8 includes the apparatus of any preceding clause, wherein the ones of the plurality of intermediary devices is at least one of a bell crank or a pin and slot assembly.

Example 9 includes the apparatus of any preceding clause, further including a plurality of actuators corresponding to the plurality of intermediary devices, ones of the plurality of actuators operatively to the plurality of intermediary devices, the ones of the plurality of actuators to move between the first position and the second position to cause respective ones of the plurality of intermediary devices to move between the first position and the second position to cause respective ones of the plurality of VBV doors to move between the first position and the second position.

Example 10 includes the apparatus of any preceding clause, further including a first unison ring, the first unison ring positioned between the plurality of intermediary devices and the first actuator, the first unison ring operatively coupled to the first actuator and to the plurality of intermediary devices, the first actuator to move between the first position and the second position to cause the first unison ring to move between the first position and the second position to cause the plurality of intermediary devices and corresponding plurality of VBV doors to move between the first position and the second position.

Example 11 includes the apparatus of any preceding clause, wherein the first actuator is downstream of the first unison ring.

Example 12 includes the apparatus of any preceding clause, wherein the plurality of intermediary devices includes a first portion of the plurality of intermediary devices and a second portion of the plurality of intermediary devices, the first portion of the plurality of intermediary devices operatively coupled to the first unison ring, the variable bleed valve system further including a second unison ring, the second portion of the plurality of intermediary devices operatively coupled to the second unison ring, and a second actuator operatively coupled to the second unison ring, the second actuator to move between the first position and the second position to cause the second unison ring to move between the first position and the second position to cause the second portion of the plurality of intermediary devices and a corresponding plurality of VBV doors to move between the first position and the second position.

Example 13 includes a turbine engine comprising a casing having an inner surface and an outer surface, the casing to define a flow path for the turbine engine, the casing having a plurality of air bleed slots, and a variable bleed valve system, including a plurality of VBV doors corresponding to the plurality of air bleed slots, and a plurality of actuators corresponding to the plurality of VBV doors, ones of the plurality of actuators operatively coupled to respective ones of the VBV doors, the plurality of actuators to move between an open position and closed position to cause the plurality of VBV doors to move between the open position and the closed position.

Example 14 includes the turbine engine of any preceding clause, wherein the plurality of VBV doors are substantially flush with the flow path in the closed position.

Example 15 includes the turbine engine of any preceding clause, wherein the ones of the plurality of actuators are at least one of power screws, ball screws, or linear actuators.

Example 16 includes a turbine engine comprising a casing defining a first flow path, a variable bleed valve (VBV) port on the casing, the VBV port defining a secondary flow path, a VBV wall, the VBV wall to close off the VBV port in a first position, the VBV wall to define a VBV port wall in a second position, and a first actuator, the first actuator operatively coupled to the VBV wall, the actuator to move between the first position and a second position to cause the VBV wall to move between the first position and the second position.

Example 17 includes the turbine engine of any preceding clause, wherein the first position is a closed position and the second position is an open position.

Example 18 includes the turbine engine of any preceding clause, wherein the VBV wall at least one of (1) slides between the first position and the second position or (2) pivots about a point between the first position and the second position.

Example 19 includes the turbine engine of any preceding clause, further including a plurality of VBV ports defining a corresponding plurality of secondary flow paths, and a plurality of VBV walls corresponding the plurality of VBV ports.

Example 20 includes the turbine engine of any preceding clause, further including a plurality of actuators corresponding to the plurality of VBV walls, ones of the plurality of actuators operatively coupled to respective ones of the plurality of VBV walls.

Example 21 includes the turbine engine of any preceding clause, further including a first unison ring, the first unison ring positioned between the plurality of VBV walls and the first actuator, the first unison ring operatively coupled to the first actuator and plurality of VBV walls, the first actuator to move between the first position and the second position to cause the first unison ring to move between the first position and the second position to cause ones of a plurality VBV walls to move between the first position and the second position.

Example 22 includes an apparatus including means for bleeding air, means for covering the means for bleeding air, and means for moving the means for covering.

Example 23 includes the apparatus of any preceding clause, further including means for coupling the means for covering and the means for moving the means for covering.

Although certain example systems, apparatus, and articles of manufacture have been disclosed herein, the scope of coverage of this patent is not limited thereto. On the contrary, this patent covers all systems, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
a variable bleed valve (VBV) door corresponding to a bleed port;
an intermediary device operatively coupled to the VBV door; and
a first actuator operatively coupled to the intermediary device, the first actuator to move between a first position and a second position, the first actuator to cause the intermediary device to move between the first position and the second position to cause the VBV door to move between the first position and the second position.

2. The apparatus of claim 1, wherein the VBV door slides between the first position and the second position.

3. The apparatus of claim 1, wherein the VBV door is substantially flush with a flow path in the first position.

4. The apparatus of claim 1, further including a plurality of VBV doors corresponding a plurality of bleed ports, the plurality of VBV doors spaced circumferentially apart.

5. The apparatus of claim 4, wherein each of the plurality of VBV doors are positioned aft or forward of respective ones of the plurality of bleed ports in the second position.

6. The apparatus of claim 4, further including a plurality of intermediary devices corresponding to the plurality of VBV doors, ones of the plurality of intermediary devices operatively coupled to respective ones of the plurality of VBV doors.

7. The apparatus of claim 6, wherein the ones of the plurality of intermediary devices is at least one of a bell crank or a pin and slot assembly.

8. The apparatus of claim 6, further including a plurality of actuators corresponding to the plurality of intermediary devices, ones of the plurality of actuators operatively to the plurality of intermediary devices, the ones of the plurality of actuators to move between the first position and the second position to cause respective ones of the plurality of intermediary devices to move between the first position and the second position to cause respective ones of the plurality of VBV doors to move between the first position and the second position.

9. The apparatus of claim 6, further including a first unison ring, the first unison ring positioned between the plurality of intermediary devices and the first actuator, the first unison ring operatively coupled to the first actuator and to the plurality of intermediary devices, the first actuator to move between the first position and the second position to cause the first unison ring to move between the first position and the second position to cause the plurality of intermediary devices and corresponding plurality of VBV doors to move between the first position and the second position.

10. The apparatus of claim 9, wherein the first actuator is downstream of the first unison ring.

11. The apparatus of claim 9, wherein the plurality of intermediary devices includes a first portion of the plurality of intermediary devices and a second portion of the plurality of intermediary devices, the first portion of the plurality of intermediary devices operatively coupled to the first unison ring, the apparatus further including:
a second unison ring, the second portion of the plurality of intermediary devices operatively coupled to the second unison ring; and
a second actuator operatively coupled to the second unison ring, the second actuator to move between the first position and the second position to cause the second unison ring to move between the first position and the second position to cause the second portion of the plurality of intermediary devices and a corresponding plurality of VBV doors to move between the first position and the second position.

12. A turbine engine comprising:
a casing having an inner surface and an outer surface, the casing to define a flow path for the turbine engine, the casing having a plurality of air bleed slots; and
a variable bleed valve system, including:
a plurality of VBV doors corresponding to the plurality of air bleed slots; and
a plurality of actuators corresponding to the plurality of VBV doors, ones of the plurality of actuators operatively coupled to respective ones of the plurality of VBV doors, the plurality of actuators to move between an open position and closed position to cause the plurality of VBV doors to move between the open position and the closed position.

13. The turbine engine of claim 12, wherein the plurality of VBV doors are substantially flush with the flow path in the closed position.

14. The turbine engine of claim 12, wherein the ones of the plurality of actuators are at least one of power screws, ball screws, or linear actuators.

15. A turbine engine comprising:
a casing defining a first flow path;
a variable bleed valve (VBV) port on the casing, the VBV port defining a secondary flow path;
a VBV wall, the VBV wall to close off the VBV port in a first position, the VBV wall to define a VBV port wall in a second position; and
a first actuator, the first actuator operatively coupled to the VBV wall, the first actuator to move between the first position and the second position to cause the VBV wall to move between the first position and the second position.

16. The turbine engine of claim 15, wherein the first position is a closed position and the second position is an open position.

17. The turbine engine of claim 15, wherein the VBV wall at least one of (1) slides between the first position and the second position or (2) pivots about a point between the first position and the second position.

18. The turbine engine of claim 15, further including:
a plurality of VBV ports defining a corresponding plurality of secondary flow paths; and
a plurality of VBV walls corresponding the plurality of VBV ports.

19. The turbine engine of claim 18, further including a plurality of actuators corresponding to the plurality of VBV walls, ones of the plurality of actuators operatively coupled to respective ones of the plurality of VBV walls.

20. The turbine engine of claim 18, further including a first unison ring, the first unison ring positioned between the plurality of VBV walls and the
first actuator, the first unison ring operatively coupled to the first actuator and the plurality of VBV walls, the first actuator to move between the first position and the second position to cause the first unison ring to move between the first position and the second position to cause ones of a plurality VBV walls to move between the first position and the second position.
